(19) United States
(12) Patent Application Publication
(10) Pub. No.: US 2021/0405392 A1
(43) Pub. Date: Dec. 30, 2021

(54) PROGRESSIVE ADDITION LENSES

(71) Applicant: Hwa Meei Optical Co.,Ltd., Tainan (TW)

(72) Inventor: CHING-YAO HUANG, Tainan (TW)

(21) Appl. No.: 17/356,548

(22) Filed: Jun. 24, 2021

(30) Foreign Application Priority Data
Jun. 30, 2020 (TW) 109121985

(51) Int. Cl. G02C 7/06

(52) U.S. Cl. CPC G02C 7/063

(57) ABSTRACT

Provided is progressive addition lens without a progressive corridor and capable of eliminating the peripheral unwanted astigmatism on both sides of the central progressive zone of the lens. The three-dimensional freeform surface design of the lens and injection molding method are used to manufacture the progressive addition lens, which can provide a clear distant vision on the upper part thereof, a clear near vision on the lower part thereof, and a clear intermediate vision thereof at the middle progressive zone. The present disclosure has a wide field of view and a high definition that greatly reduces the interference of vision in the astigmatism zone.

### BACKGROUND OF THE INVENTION

### 1. Field of the Invention

The present disclosure relates to an addition lens, and particularly relates to a progressive addition lens that greatly reduces the astigmatism zone and does not have progressive corridor areas.

### 2. The Prior Arts

As shown in FIG. 1, the distant vision zone 1 of the prior art progressive addition lens is positioned on the wide area of the upper half of the lens, and is used to observe distant objects. The human eyes have the ability to correct distant vision when they are in a relaxed head-up state, and provide a clear and wide field of vision. The near vision zone 3 is positioned on the lower half of the lens, and is used to observe near objects with a small clear range of vision. The progressive corridor zone 5 is positioned on the middle area between the distant vision zone and the near vision zone. The progressive corridor zone 5 is used to observe objects at an intermediate distance, and has a narrow range of visual clarity. The astigmatism zone 7 (also known as a blind zone) is positioned on both sides of the lens, and cannot be provided for a wearer to observe. At the same time, it can be expressly seen from the contour diagram shown in FIG. 2 that the contour lines of the astigmatism zone 7 are densely spaced such that the visual blur and shaking sensation caused by the astigmatism zone 7 will be obvious, and makes the wearer feel dizzy and uncomfortable.

In addition, taking the long distance as the design core will make the long-distance field of view wider, and the intermediate-distance and short-distance breath must be sacrificed, resulting in a narrower intermediate-range and short-range field of view. If the wearer wears the lenses for a long time, since the near vision zone 3 is too narrow, it is necessary to turn the head frequently to align with the area to be viewed, and it is easy to tilt the head for a long time, resulting in shoulder and neck compression and fatigue and pain. If the eyes look at the target through the near vision zone of a small area for a long time, it is also easy to cause eyes fatigue and feel sore.

Therefore, it is imperative to provide a better progressive addition lens to overcome the aforementioned shortcomings.

### SUMMARY OF THE INVENTION

In order to achieve the above objective, according to a preferred embodiment, the present disclosure provides a progressive addition lens. That is, a lens that has no progressive corridor zone and greatly reduced peripheral astigmatism zones on both sides of the center of the lens (i.e., the middle area), and can customize the curved surface according to the wearer's face shape, function requirements and visual requirements, and can be manufactured directly from the mold.

According to an embodiment of the present disclosure, the progressive addition lens includes a distant vision zone on an upper part of a lens; a near vision zone on a lower part of the lens; and an intermediate vision zone on a middle part of the lens and between the distant vision zone and the near vision zone, wherein an astigmatism zone is on both sides of the intermediate vision zone, wherein the lens is directly molded by a mold, a rear surface of the lens is a freeform surface, the intermediate vision zone increases a field of view by the freeform surface, forms an area that does not have a progressive corridor area and reduces the astigmatism zone, and a ratio of the astigmatism zone and the intermediate vision zone is between 5% and 20%.

Preferably, the rear surface of the lens is composed of a combination of a primary structure height function and a secondary structure height function.

Preferably, the primary structure height function is determined by all of or part of the combination of shape functions that control a variation of a vertical degree in a Zernike function, and the shape functions include Z₃ to Z₂₇.

Preferably, the Zernike function is determined according to the following formula:

$${Z}_{k} ( x , y ) = \{ \begin{matrix}\sqrt{n + 1} {\sum }_{b = 0}^{n / 2} {\sum }_{c = 0}^{n / 3 - b} {( - 1 )}^{b} \frac{( n - b ) !}{b ! ( n / 2 - b ) ! ( n / 2 - b - c ) ! c !} {x}^{n - 2 b - 2 c} {y}^{2 c} & if m = 0 \\ \begin{matrix}\sqrt{2 ( n + 1 )} {\sum }_{a = 0}^{ln ( m / 2 )} {\sum }_{b = 0}^{( n - m ) / 2} {\sum }_{c = 0}^{( n - m ) / 2 - b} {( - 1 )}^{a + b} ( \begin{matrix}m \\ 2 a\end{matrix} ) \times \\ \frac{( n - b ) !}{b ! [ ( n + m ) / 2 - b ] ! [ ( n - m ) / 2 - b - c ] ! c !} {x}^{n - 2 a - 2 b - 2 c} {y}^{2 a + 2 c}\end{matrix} & if m \neq 0 and k even \\ \begin{matrix}\sqrt{2 ( n + 1 )} {\sum }_{a = 0}^{ln ( m / 2 )} {\sum }_{b = 0}^{( n - m ) / 2} {\sum }_{c = 0}^{( n - m ) / 2 - b} {( - 1 )}^{a + b} ( \begin{matrix}m \\ 2 a + 1\end{matrix} ) \times \\ \frac{( n - b ) !}{b ! [ ( n + m ) / 2 - b ] ! [ ( n - m ) / 2 - b - c ] ! c !} {x}^{n - 2 a - 2 b - 2 c - 1} {y}^{2 a + 2 c + 1}\end{matrix} & if m \neq 0 and k odd\end{matrix} .$$

where k is the k-th polynomial (integer of k≥0), x is a horizontal coordinate, y is a vertical coordinate, m is an angular frequency, n is the n-th order aberration, and a, b and c are all integers greater than or equal to 0.

Preferably, the secondary structure height function includes Z₆ to Z₂₇ in addition to the Zernike function used in the primary structure height function.

Preferably, a front surface of the lens is a spherical surface, an aspherical surface, a spherocylindrical surface or a combination thereof.

Preferably, the spherical surface or the aspherical surface is determined according to the following formula:

x²+y²+(1+Q)z²−2zR=0

where x is the x axis of a coordinate system on a surface of the lens, y is the y axis of the coordinate system of the surface of the lens, z is a surface height, R is a radius of curvature of an apex of the lens, and Q is the spherical surface or the aspherical surface (Q=0 represents the spherical surface, and WO represent the aspherical surface).

Preferably, the spherocylindrical surface is determined according to the following formula:

F(θ)=S+C sin²(θ−α), and R(θ)=(n₂−n₁)/F(θ),

where s is the degree of the spherical surface, c is the degree of the cylindrical surface, a is the cylindrical axis, F(θ) is the degree at an angle θ, R(θ) is the radius of curvature at the angle θ, n₁ is the refractive index of air (n₁=1.0), and n₂ is the refractive index of the lens.

Preferably, the lens is manufactured by one of injection molding and casting molding methods.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of a prior art progressive addition lens.

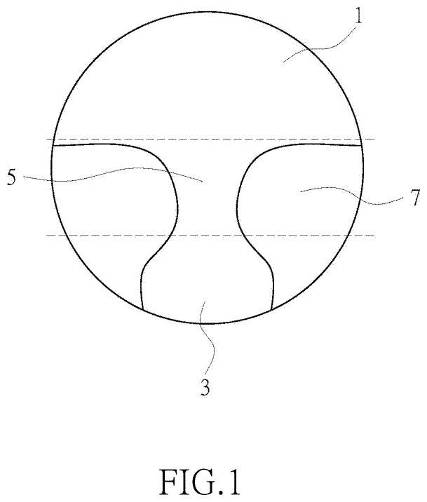

FIG. 2 is a contour map of astigmatism of a prior art progressive addition lens.

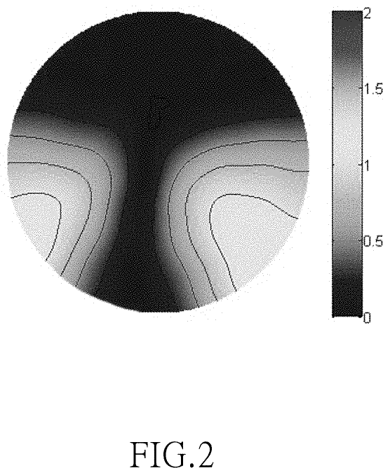

FIG. 3 shows a schematic diagram of a progressive addition lens according to the present disclosure.

FIG. 4 shows a simulated contour diagram of equivalent spherical power (M) of the progressive addition lens (ϕ=67 mm) according to the first embodiment of the present disclosure.

FIG. 5 shows a simulated contour diagram of astigmatism (J) of the progressive addition lens (ϕ=67 mm) according to the first embodiment of the present disclosure.

FIG. 6 shows a measured contour diagram of equivalent spherical power (M) of the progressive addition lens (ϕ=67 mm) according to the second embodiment of the present disclosure (where only the progressive addition lens (ϕ=40 mm) is shown).

FIG. 7 shows a measured contour diagram of astigmatism (J) of the progressive addition lens (ϕ=67 mm) according to the second embodiment of the present disclosure (where only the progressive addition lens (ϕ=40 mm) is shown).

FIG. 8 shows a simulated contour diagram of equivalent spherical power (M) of the progressive addition lens according to the third embodiment of the present disclosure.

FIG. 9 shows a simulated contour diagram of astigmatism (J) of the progressive addition lens (ϕ=67 mm) according to the third embodiment of the present disclosure.

FIG. 10 shows a schematic diagram of a mold forming of the progressive addition lens according to the present disclosure.

### DETAILED DESCRIPTION OF THE PREFERRED EMBODIMENT

The detailed description of the present disclosure is provided in combination with the accompanying drawings.

In general, in the case of ignoring the thickness of the lens (thin lens), the total power of the lens can be determined by the sum of the surface powers of the two surfaces of the lens (i.e., the front surface and the rear surface), and the surface power of the lens is calculated from the refractive index (n) and radius of curvature (R) of the lens. Consequently, the refractive index of the lens can be determined when the material of the lens is known. In addition, as long as the shapes of the front and rear surfaces of the lens are determined, the surface power of lens can be known.

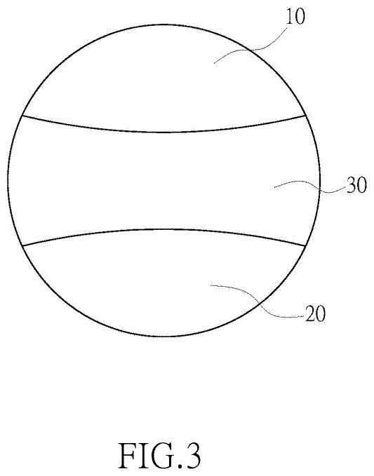

The front surface of the lens of the present disclosure may be a spherical surface, an aspherical surface, a spherocylindrical surface and a combination thereof, and the rear surface of the lens is a freeform surface, but not limited thereto. Therefore, as shown in FIG. 3, a progressive addition lens proposed by the present disclosure includes a distant vision zone 10, a near vision zone 20 and an intermediate vision zone 30. The distant vision 10 is arranged at the upper part of the lens, and used to see distant objects clearly. The near vision zone 20 is provided at the lower part of the lens, and used to see objects at close range clearly. The intermediate vision zone 30 is provided at the middle part of the lens and between the distant vision zone and the near vision zone, and used to see object in the middle distance.

It is worth noting that the intermediate vision zone of the present disclosure does not have progressive corridor areas, and the astigmatism areas on both sides of the intermediate vision zone are greatly eliminated such that the progressive addition lens of the present disclosure has a wide field of view and high definition that greatly eliminates astigmatism from interfering with vision. That is, the ratio of the astigmatism zone to the intermediate vision is about 5%-20%, and the best is about 5%-10%.

If the front surface of the present disclosure is spherical or aspherical, it is determined according to the following formula:

x²+y²+(1+Q)z²−2zR=0′ (1)

where x is the x axis of a coordinate system on a surface of the lens, y is the y axis of the coordinate system of the surface of the lens, z is a surface height, R is a radius of curvature of an apex of the lens, and Q is the spherical surface or the aspherical surface (Q=0 represents the spherical surface, and WO represent the aspherical surface).

If the front surface of the present disclosure is a spherocylindrical, it is determined according to the following formula:

F(θ)=S+C sin²(θ−α), and (2)

R(θ)=(n₂−n₁)/F(θ), (3)

where s is the degree of the spherical surface, c is the degree of the cylindrical surface, α is the cylindrical axis, F(θ) is the degree at an angle θ, R(θ) is the radius of curvature at the angle θ, n₁ is the refractive index of air (n₁=1.0), and n₂ is the refractive index of the lens.

The rear surface of the progressive addition lens of the present disclosure adopts a freeform surface design. Accordingly, the full surface height function of the present disclosure can be obtained by combining both a primary structure height function and a secondary structure height function.

The primary structure height function is mainly used to design the height and rate of change of the far-use degree and the near use add-on degree, and is composed of all or partial combinations of the shape functions that control the vertical degree changes in the Zernike polynomial. The shape functions include Z₃ to Z₂₇ (please refer to the Zernike polynomials below and Table 1 below).

The height function (Zₖ(x, y)) of the lens surface geometry can be described by the combination of Zernike polynomials representing the shape of the aberration surface:

$${Z}_{k} ( x , y ) = \{ \begin{matrix}\sqrt{n + 1} {\sum }_{b = 0}^{n / 2} {\sum }_{c = 0}^{n / 3 - b} {( - 1 )}^{b} \frac{( n - b ) !}{b ! ( n / 2 - b ) ! ( n / 2 - b - c ) ! c !} {x}^{n - 2 b - 2 c} {y}^{2 c} & if m = 0 \\ \begin{matrix}\sqrt{2 ( n + 1 )} {\sum }_{a = 0}^{ln ( m / 2 )} {\sum }_{b = 0}^{( n - m ) / 2} {\sum }_{c = 0}^{( n - m ) / 2 - b} {( - 1 )}^{a + b} ( \begin{matrix}m \\ 2 a\end{matrix} ) \times \\ \frac{( n - b ) !}{b ! [ ( n + m ) / 2 - b ] ! [ ( n - m ) / 2 - b - c ] ! c !} {x}^{n - 2 a - 2 b - 2 c} {y}^{2 a + 2 c}\end{matrix} & if m \neq 0 and k even \\ \begin{matrix}\sqrt{2 ( n + 1 )} {\sum }_{a = 0}^{ln ( m / 2 )} {\sum }_{b = 0}^{( n - m ) / 2} {\sum }_{c = 0}^{( n - m ) / 2 - b} {( - 1 )}^{a + b} ( \begin{matrix}m \\ 2 a + 1\end{matrix} ) \times \\ \frac{( n - b ) !}{b ! [ ( n + m ) / 2 - b ] ! [ ( n - m ) / 2 - b - c ] ! c !} {x}^{n - 2 a - 2 b - 2 c - 1} {y}^{2 a + 2 c + 1}\end{matrix} & if m \neq 0 and k odd\end{matrix} . \qquad ( 4 )$$

where k is the k-th polynomial (integer of k≥0), x is a horizontal coordinate, y is a vertical coordinate, m is an angular frequency, n is the n-th order aberration, and a, b and c are all integers greater than or equal to 0.

Moreover, under the condition that the secondary structure height function does not affect the equivalent spherical power (M) distribution presented by the primary structure height function, the added high-order Zernike function is mainly used to design the distribution, reduction and removal of the astigmatism power. In addition to the above-mentioned Zernike function used in the primary structure height function. The secondary structure height function includes Z₆ to Z₂₇ (please refer to the following Zernike polynomials and Table 1).

Using the aforesaid full surface height function of the lens of the present disclosure, the combination of Zernike polynomials up to sixth order and the Zernike coefficients thereof can be derived. The Zernike coefficients are variable. After that, the equivalent spherical power and astigmatism power of the lens can be calculated according to the coefficients brought into the polynomials according to the following formula:

$$\begin{matrix}M = \frac{- 4 \sqrt{3} {c}_{2}^{0} + 12 \sqrt{5} {c}_{4}^{0} - 24 \sqrt{7} {c}_{6}^{0} + ⋯}{{r}^{2}} & ( 5 ) \\ {J}_{0} = \frac{- 2 \sqrt{6} {c}_{2}^{2} + 6 \sqrt{10} {c}_{4}^{2} - 12 \sqrt{14} {c}_{6}^{2} + ⋯}{{r}^{2}} & ( 6 ) \\ {J}_{45} = \frac{- 2 \sqrt{6} {c}_{2}^{- 2} + 6 \sqrt{10} {c}_{4}^{- 2} - 12 \sqrt{14} {c}_{6}^{- 2} + ⋯}{{r}^{2}} & ( 7 ) \\ J = \sqrt{{{J}_{0}}^{2} + {{J}_{45}}^{2}} & ( 8 )\end{matrix}$$

where cₙ^{m} is the Zernike coefficient of the nth-order aberration angular frequency m, r is the simulated pupil radius (here set to 2.25 mm), M is the equivalent spherical power, J₀ is the power of orthogonal astigmatism, J₄₅ is the power of oblique astigmatism, and J is the power of astigmatism.

In order to facilitate the understanding of the design of the progressive addition lens of the present disclosure, the present disclosure provides the following specific embodiments, which are described as follows.

### First Embodiment

In the first embodiment of the present disclosure, the material thereof is PC (n=1.586), the prescription thereof is plano/+2.00 Add, the diameter thereof is 67 mm, the front surface shape of the progressive addition lens is designed to be Q=0 (spherical), and the base curve is +4.50 D. Therefore, the design of the rear surface shape of the progressive addition lens of the present disclosure is as follows.

In the first embodiment of the present disclosure, the primary structure height function is determined according to the following formula:

$${Z}_{k} ( x , y ) = {C}_{4} {Z}_{4} ( x , y ) + {C}_{7} {Z}_{7} ( x , y ) + {C}_{12} {Z}_{12} ( x , y ) + {C}_{17} {Z}_{17} ( x , y ) + {C}_{25} {Z}_{25} ( x , y ) = {C}_{4} \sqrt{3} ( 2 {x}^{2} + 2 {y}^{2} - 1 ) + {C}_{7} 2 \sqrt{2} ( 3 {x}^{2} y + 3 {y}^{3} - 2 y ) + {C}_{12} \sqrt{5} ( 6 {x}^{4} + 12 {x}^{2} {y}^{2} + 6 {y}^{4} - 6 {x}^{2} - 6 {y}^{2} + 1 ) + {C}_{17} \sqrt{12} ( 10 {x}^{4} y + 20 {x}^{2} {y}^{3} + 10 {y}^{5} - 12 {x}^{2} y - 12 {y}^{3} + 3 y ) + {C}_{25} \sqrt{14} ( 15 {x}^{6} + 15 {x}^{4} {y}^{2} - 15 {x}^{2} {y}^{4} - 20 {x}^{4} + 6 {x}^{2} - 15 {y}^{6} + 20 {y}^{4} - 6 {y}^{2} ) \qquad ( 9 )$$

In the first embodiment of the present disclosure, the secondary structure height function is determined according to the following formula:

Zₖ(x,y)=0 (10)

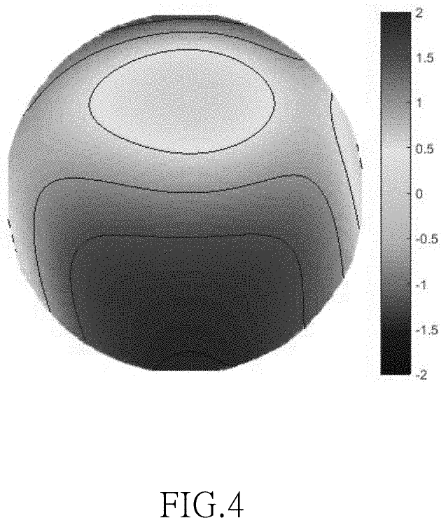

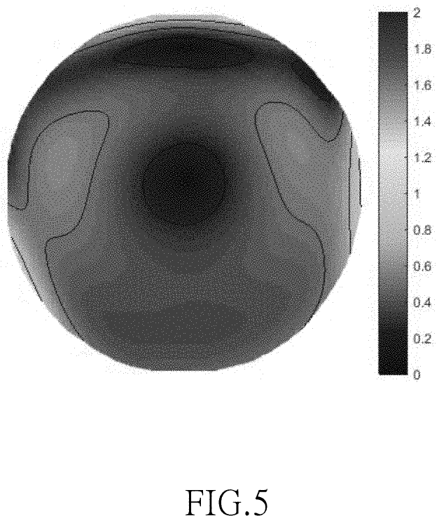

With the design of the rear surface shape of the progressive addition lens described above, FIG. 4 shows a simulated contour diagram of equivalent spherical power (M) of the progressive addition lens (ϕ=67 mm) according to the first embodiment of the present disclosure, and FIG. 5 shows a simulated contour diagram of astigmatism (J) of the progressive addition lens (ϕ=67 mm) according to the first embodiment of the present disclosure. It can be explicitly seen from FIGS. 4 and 5 that the progress addition lens of the present disclosure has a wide field of view and high definition since the present disclosure does not have progressive corridor areas and has an extremely small peripheral astigmatism area (the area of J≤+0.50 D defined as the acceptable intermediate vision zone).

### Second Embodiment

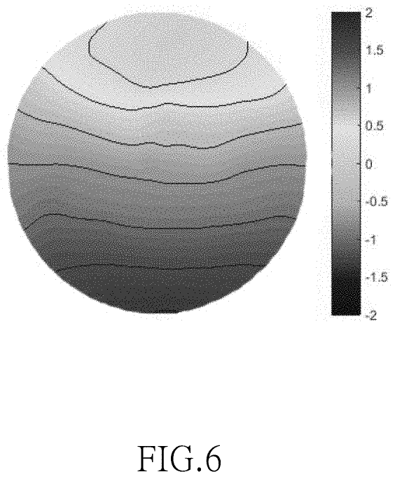

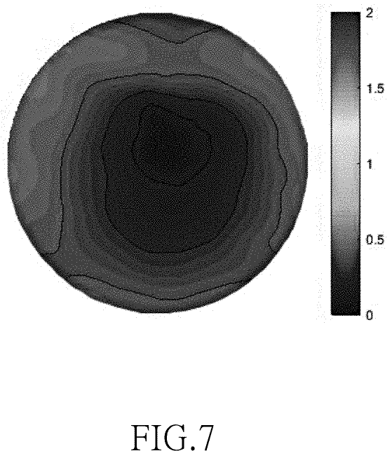

In the second embodiment of the present disclosure, the material thereof is PC (n=1.586), the prescription thereof is plano/+2.00 Add, the diameter thereof is 67 mm, the front surface shape of the progressive addition lens is designed to be Q=0 (spherical), and the base curve is +4.50 D. FIG. 6 shows a measured contour diagram of equivalent spherical power (M) of the progressive addition lens (ϕ=67 mm) according to the second embodiment of the present disclosure (where only the progressive addition lens (ϕ=40 mm) is shown). FIG. 7 shows a measured contour diagram of astigmatism (J) of the progressive addition lens (ϕ=67 mm) according to the second embodiment of the present disclosure (where only the progressive addition lens (ϕ=40 mm) is shown). It can be explicitly seen from FIGS. 6 and 7 that the progress addition lens of the present disclosure has a wide field of view and significantly reduces the interference of peripheral astigmatism with high definition vision since the present disclosure does not have progressive corridor areas and has greatly reduced peripheral astigmatism area (the area of J≤+0.50 D defined as the acceptable intermediate vision zone).

In light of the above, the detection methods of lens power distribution can be divided into optical and non-optical methods. The optical methods can be divided into Moire optical interference technology and wave-front aberration detection technology. The non-optical methods are mainly to scan the height change on the lens with a three-dimensional measuring bed, and then convert it into a power distribution diagram.

The measured diagram of the second embodiment of the present disclosure is that after the previous wave-front aberration detector measures the power of the entire surface of the lens to obtain data, the contour diagram is drawn with MATLAB software. The actual mass-produced lens of the second embodiment is tested by the instrument. The detection is mainly based on the center of the lens, and the lens area with a diameter of 40 mm is the actual measurement range. The lens area within this range is sufficient to cover all important optical areas of current progressive lenses. The actual measurement diagrams are shown in FIGS. 6 and 7. The second embodiment of the present disclosure does not have progressive corridor areas, and the peripheral astigmatism zone (the area of J≤+0.50D as the acceptable intermediate vision zone) of the lens of the second embodiment only occupy a relatively small area of the lens. As such, the progressive addition lens of the present disclosure has a wide field of view and high definition.

### Third Embodiment

In the third embodiment of the present disclosure, the material thereof is PC (n=1.586), the prescription thereof is plano/+2.00 Add, the diameter thereof is 67 mm, the front surface shape of the progressive addition lens is designed to be Q=0 (spherical), and the base curve is +4.50 D. Therefore, the design of the rear surface shape of the progressive addition lens of the present disclosure is as follows.

In the third embodiment of the present disclosure, the primary structure height function is also determined according to the above formula, while the secondary structure height function is determined according to the following formula:

Zₖ(x,y)=C₁₅Z₁₅(x,y)=C₁₅√12(5x⁴y−10x²y³+y⁵) (11)

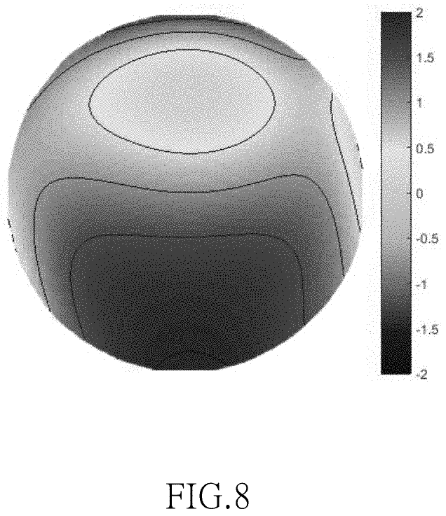

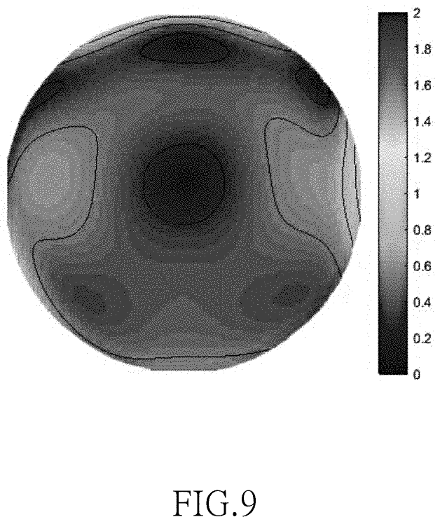

With the design of the rear surface shape of the progressive addition lens mentioned above, FIG. 8 shows a simulated contour diagram of equivalent spherical power (M) of the progressive addition lens (ϕ=67 mm) according to the third embodiment of the present disclosure, and FIG. 9 shows a simulated contour diagram of astigmatism (J) of the progressive addition lens (ϕ=67 mm) according to the third embodiment of the present disclosure. It can be explicitly seen from FIGS. 8 and 9 that the progress addition lens of the present disclosure has a wide field of view and high definition since the present disclosure does not have progressive corridor areas and has an extremely small peripheral astigmatism area (the area of J≤+0.50 D defined as the acceptable intermediate vision zone).

It is worth mentioning that the Zernike coefficients of the above specific embodiments of the present disclosure are shown in Table 1.

TABLE 1
Zernike coefficients of the surface height function of
the progressive addition lens of the present disclosure

| k of Zₖ(x, y) | | PAL front | PAL rear | PAL sum of |
|---|---|---|---|---|
| and Cₖ | Cₙ^{m}(x, y) | surface (μm) | surface (μm) | two surfaces (μm) |
| 3 | C₂⁻² | 0.1 | −0.1 | 0.2 |
| 4 | C₂⁰ | −1262.8 | 975.5 | −287.2 |
| 5 | C₂⁺² | 0.1 | −0.1 | 0.0 |
| 6 | C₃⁻³ | 0.1 | −0.1 | 0.0 |
| 7 | C₃⁻¹ | 0.1 | 79.9 | 80.0 |
| 8 | C₃⁺¹ | 0.1 | −0.1 | 0.2 |
| 9 | C₃⁺³ | 0.1 | −0.1 | 0.2 |
| 10 | C₄⁻⁴ | 0.1 | −0.1 | 0.2 |
| 11 | C₄⁻² | 0.1 | −0.1 | 0.2 |
| 12 | C₄⁰ | −5.4 | 2.5 | −3.0 |
| 13 | C₄⁺² | 0.1 | −0.1 | 0.0 |
| 14 | C₄⁺⁴ | 0.1 | −0.1 | 0.0 |
| 15 | C₅⁻⁵ | 0.1 | −0.1 | 0.0 |
| 16 | C₅⁻³ | 0.1 | −0.1 | 0.0 |
| 17 | C₅⁻¹ | 0.1 | −10.1 | −10.0 |
| 18 | C₅⁺¹ | 0.1 | −0.1 | 0.2 |
| 19 | C₅⁺³ | 0.1 | −0.1 | 0.2 |
| 20 | C₅⁺⁵ | 0.1 | −0.1 | 0.2 |
| 21 | C₆⁻⁶ | 0.1 | −0.1 | 0.2 |
| 22 | C₆⁻⁴ | 0.1 | −0.1 | 0.2 |
| 23 | C₆⁻² | 0.1 | −0.1 | 0.2 |
| 24 | C₆⁰ | 0.1 | −0.1 | 0.0 |
| 25 | C₆⁺² | 0.1 | 3.2 | 3.4 |
| 26 | C₆⁺⁴ | 0.1 | −0.1 | 0.0 |
| 27 | C₆⁺⁶ | 0.1 | −0.1 | 0.0 |

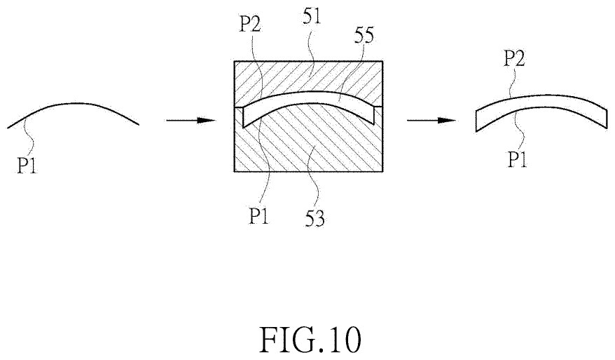

In addition, please note that, as shown in FIG. 10, the progressive addition lens of the present disclosure is manufactured by the freeform optical design of the three-dimensional space on the rear surface of the lens and directly molded by a mold. Hence, the upper part of the lens can be used to see objects at a long distance, the lower part of the lens can be used to see objects at a close distance, and the middle part of the lens can be used to see objects at an intermediate distance. Moreover, the front surface of the lens of the present disclosure is formed by a spherical mold, an aspherical mold or a spherocylindrical mold 51, but not limited thereto, and the rear surface of the lens of the present disclosure is formed by a freeform mold 53, but not limited thereto. As a result, the progressive addition lens of the present disclosure can have the advantages of a wide field of view and a small peripheral astigmatism area that interferes with vision and high definition.

The front and rear surfaces of the lens are manufactured by one of injection molding and casting molding. Injection molding and casting molding methods refer to the required curvature of the front and rear surfaces of the lens, which are directly molded in a mold. It is mainly to design freeform surface P1 of the rear surface of the lens by combining the correction power with the primary structure height function and the secondary structure height function. Subsequently, the spherical, aspherical, spherocylindrical surface P2 or the combination thereof of the front surface of the lens and the aforementioned freeform surface P1 are respectively set on the male mold 51 and the female mold 53 of the mold. After being aligned, the lens of the present disclosure is directly molded in the molding cavity 55.

Although the present disclosure has been described with reference to the preferred exemplary preferred embodiments thereof, it is apparent to those skilled in the art that a variety of modifications and changes may be made without departing from the scope of the present disclosure which is intended to be defined by the appended claims.

What is claimed is:

1. A progressive addition lens, comprising:
a distant vision zone at an upper part of a lens;
a near vision zone at a lower part of the lens; and
a intermediate vision zone at a middle part of the lens and between the distant vision zone and the near vision zone, wherein an astigmatism zone is on both sides of the intermediate vision zone,
wherein the lens is directly molded by a mold, a rear surface of the lens is a freeform surface, the intermediate vision zone increases a field of view by the freeform surface, forms an area that does not have a progressive corridor area and reduces the astigmatism zone, and a ratio of the astigmatism zone to the intermediate vision zone is between 5% and 20%,
wherein the rear surface of the lens is composed of a combination of a primary structure height function and a secondary structure height function, and
wherein the primary structure height function is determined by all of or part of the combination of shape functions that control a variation of a vertical degree in a Zernike function, and the shape functions include Z₃ to Z₂₇.

2. The progressive addition lens of claim 1, wherein the Zernike function is determined according to the following formula:
$${Z}_{k} ( x , y ) = \{ \begin{matrix}\sqrt{n + 1} {\sum }_{b = 0}^{n / 2} {\sum }_{c = 0}^{n / 3 - b} {( - 1 )}^{b} \frac{( n - b ) !}{b ! ( n / 2 - b ) ! ( n / 2 - b - c ) ! c !} {x}^{n - 2 b - 2 c} {y}^{2 c} & if m = 0 \\ \begin{matrix}\sqrt{2 ( n + 1 )} {\sum }_{a = 0}^{ln ( m / 2 )} {\sum }_{b = 0}^{( n - m ) / 2} {\sum }_{c = 0}^{( n - m ) / 2 - b} {( - 1 )}^{a + b} ( \begin{matrix}m \\ 2 a\end{matrix} ) \times \\ \frac{( n - b ) !}{b ! [ ( n + m ) / 2 - b ] ! [ ( n - m ) / 2 - b - c ] ! c !} {x}^{n - 2 a - 2 b - 2 c} {y}^{2 a + 2 c}\end{matrix} & if m \neq 0 and k even \\ \begin{matrix}\sqrt{2 ( n + 1 )} {\sum }_{a = 0}^{ln ( m / 2 )} {\sum }_{b = 0}^{( n - m ) / 2} {\sum }_{c = 0}^{( n - m ) / 2 - b} {( - 1 )}^{a + b} ( \begin{matrix}m \\ 2 a + 1\end{matrix} ) \times \\ \frac{( n - b ) !}{b ! [ ( n + m ) / 2 - b ] ! [ ( n - m ) / 2 - b - c ] ! c !} {x}^{n - 2 a - 2 b - 2 c - 1} {y}^{2 a + 2 c + 1}\end{matrix} & if m \neq 0 and k odd\end{matrix} .$$
where k is the k-th polynomial (integer of k≥0), x is a horizontal coordinate, y is a vertical coordinate, m is an angular frequency, n is the n-th order aberration, and a, b and c are all integers greater than or equal to 0.

3. The progressive addition lens of claim 1, wherein the secondary structure height function includes Z₆ to Z₂₇ in addition to the Zernike function used in the primary structure height function.

4. The progressive addition lens of claim 1, wherein a front surface of the lens is a spherical surface, an aspherical surface, a spherocylindrical surface or a combination thereof.

5. The progressive addition lens of claim 4, wherein the spherical surface or the aspherical surface is determined according to the following formula:
X²+y²+(1+Q)z²−2zR=0
where x is the x axis of a coordinate system on a surface of the lens, y is the y axis of the coordinate system of the surface of the lens, z is a surface height, R is a radius of curvature of an apex of the lens, and Q is the spherical surface or the aspherical surface (Q=0 represents the spherical surface, and Q≠0 represent the aspherical surface).

6. The progressive addition lens of claim 4, wherein the spherocylindrical surface is determined according to the following formula:
F(θ)=S+C sin²(θ−α), and
R(θ)=(n₂−n₁)/F(θ),
where s is the degree of the spherical surface, c is the degree of the cylindrical surface, a is the cylindrical axis, F(θ) is the degree at an angle θ, R(θ) is the radius of curvature at the angle θ, n₁ is the refractive index of air (n₁=1.0), and n₂ is the refractive index of the lens.

7. The progressive addition lens of claim 1, wherein the lens is manufactured by one of injection molding and casting molding methods.

8. The progressive addition lens of claim 4, wherein the lens is manufactured by one of injection molding and casting molding methods.
